(19) United States
(12) Patent Application Publication
(10) Pub. No.: US 2016/0118929 A1
(43) Pub. Date: Apr. 28, 2016

(54) Solar Panel Rack Assembly

(71) Applicant: William Krause, Princeton, NJ (US)

(72) Inventor: William Krause, Princeton, NJ (US)

(21) Appl. No.: 14/922,669

(22) Filed: Oct. 26, 2015

Related U.S. Application Data
(60) Provisional application No. 62/068,956, filed on Oct. 27, 2014.

(51) Int. Cl. H02S 20/32; H02S 99/00

(52) U.S. Cl. CPC H02S 20/32; H02S 99/00

(57) ABSTRACT

A solar panel rack assembly. The assembly is configured to pivotably support one or more solar panels. A microcontroller and gear system adjusts the angle at which the solar panels supported by the assembly are disposed throughout the day, thereby allowing the solar panels to track the path of the sun, which maximizes the impingement of solar energy on the panels and more evenly distributes daily electrical production during daylight hours. The assembly includes a panel lock configured to simultaneously support multiple solar panels, which allows for the solar panels to be connected together in arrays without the need for a racking for each individual solar panel.

### CROSS REFERENCE TO RELATED APPLICATIONS

This application claims the benefit of U.S. Provisional Application No. 62/068,956 filed on Oct. 27, 2014. The above identified patent application is herein incorporated by reference in its entirety to provide continuity of disclosure.

### BACKGROUND OF THE INVENTION

The present invention relates to solar panel racking. Specifically, the present invention relates to solar panel racking configured to adjust the angle at which the solar panel array is disposed.

The incorporation of solar energy production into the world's electrical energy system is well established. As a viable, near term contributor to fighting the undeniable polluting effects of fossil fuels and their effect on global warming and corresponding climate change, solar panels are rapidly becoming the physical embodiment of man's technological prowess to curb this life threatening atmospheric corruption. The problem is that an overwhelming number of solar panel installations worldwide face south in the Northern hemisphere and north in the Southern hemisphere in a fixed position so that their kilowatt production occurs primarily over the midday period. This creates the noontime bell curve of abundant wattage flowing into the grid, or off grid in other cases. However, this bell curve wherein the largest energy production occurs during midday does not correspond to consumption patterns, particularly in the developed world. The profile of consumption, again worldwide, is minor peak loads in the earlier hours of the day and then major peak load demand in the later afternoon hours, reflecting the human activity of going and coming from home to work. The disparity between energy production and consumption patterns is exaggerated in the summer months, due to air conditioning and other such factors. Therefore, grid failures primarily occur in late summer afternoons or early evenings and the current pattern of solar energy production is largely ineffective in dealing with these established consumption patterns.

As a result of these reasons, solar arrays must evolve towards sun tracking capability in order to both enhance production and level production throughout the daylight span to avoid the midday bell curve of production that does not correspond to consumption patterns. Currently existing tracking systems for solar arrays are costly, cumbersome, and highly maintenance prone, so much so that most installations opt for the much less costly path of adding more inexpensive panels to fulfill array requirements, which in turn further compounds the problem of abundant supply when there are lower needs. Therefore, there is a need for a mechanized solar panel rack and tracking system that is economical and requires minimal maintenance.

### SUMMARY OF THE INVENTION

In view of the foregoing disadvantages inherent in the known types of solar panel racking assemblies now present in the prior art, the present invention provides a solar panel racking assembly that utilizes micro motors, programmed controllers, and simple physics by rotating the panel from a center support point to minimize torque force, and coupling panels with a unique panel lock in a multi-panel array so all panels move in a synchronized, timed motion tracking the sun's daily movement.

An illustrative embodiment of the present solar panel rack assembly comprises a housing containing a motor operably coupled to a first gear, e.g. a screw or worm gear. The rack assembly further comprises a panel lock to which a solar panel is securable having a second gear, i.e. semi-circular or circular gear, extending therefrom. When the housing and the panel lock are secured together, the worm gear operably engages the panel lock gear, thereby allowing rotation of the worm gear to control the angle at which the panel lock is disposed. A logic, e.g. a timing circuit or a controller, is operably coupled to the motor to selectively cause the motor to adjust the position of the panel lock (and the one or more solar panels connected thereto) to a set angle at a set time interval in order to track the movement of the sun throughout the day so that the solar panel is substantially perpendicular to the sun at all times. The angle and the time interval at which the solar panel is adjusted is calculated to track the expected movement of the sun.

The present rack assembly is a free-standing unit that does not require substantial superstructure nor high-powered motorization and is thus usable by a wide range of individuals without the need for substantial installation skill, time, or effort. Furthermore, the components of the present rack assembly are configured to be removably connected to each other and interchangeable, thereby allowing for damaged components to be quickly and easily swapped out for new components. For example, the motor housing can be removed by an unskilled laborer simply by removing a single fastener, detaching two struts, and then replacing the removed motor housing with a new, standardized motor housing. The motor housing is engineered such that by simply fastening the worm gear to the motor housing, the gears are automatically aligned and the laborer does not need to do any further work or make any further modifications. Furthermore, an embodiment of the present rack assembly is configured to detect the occurrence of high wind speeds and automatically adjust the positioning of the solar panel in order to minimize the profile of the solar panel and thereby minimize the potential likelihood for damage to the solar panel and the rack assembly.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of a first embodiment of the present invention.

FIG. 1B shows a perspective view of a second embodiment of the present invention.

FIG. 2 shows an exploded view of an embodiment of the present invention.

FIG. 3 shows a perspective view of an embodiment of the present invention wherein two solar panels are connected in series.

FIG. 4 shows a diagram of the time-sensitive adjustment of the angle at which a solar panel is disposed by an embodiment of the present invention.

FIG. 5 shows a diagram of the wind force-sensitive adjustment of the angle at which a solar panel is disposed by an embodiment of the present invention.

FIG. 6 shows a perspective view of an embodiment of the present invention wherein several solar panels are connected in an array.

FIG. 7 shows a perspective view of an alternative embodiment of the present invention in a stowed configuration.

### DETAILED DESCRIPTION OF THE INVENTION

Reference is made herein to the attached drawings. Like reference numerals are used throughout the drawings to depict like or similar elements of the solar panel support assembly. The figures are intended for representative purposes only and should not be considered to be limiting in any respect.

An illustrative embodiment of the present solar panel support assembly is configured to support one or more solar panels and automatically adjust the angle at which the one or more solar panels are positioned throughout the day in order to track the movement of the sun. Tracking the movement of the sun maximizes the impingement of solar energy upon the one or more solar panels and thereby maximizes the power generated by the solar panel array. Furthermore, multiple solar panels are connectable in series via a panel lock device so that the solar panels in the array are movable in unison. An illustrative embodiment of the present solar panel support assembly is further configured to detect when wind forces on the panel exceed a threshold value and then adjust the angle at which the solar panel is positioned to minimize the profile of the solar panel relative to the direction of the wind movement, thereby reducing the wind forces exerted on the solar panel array.

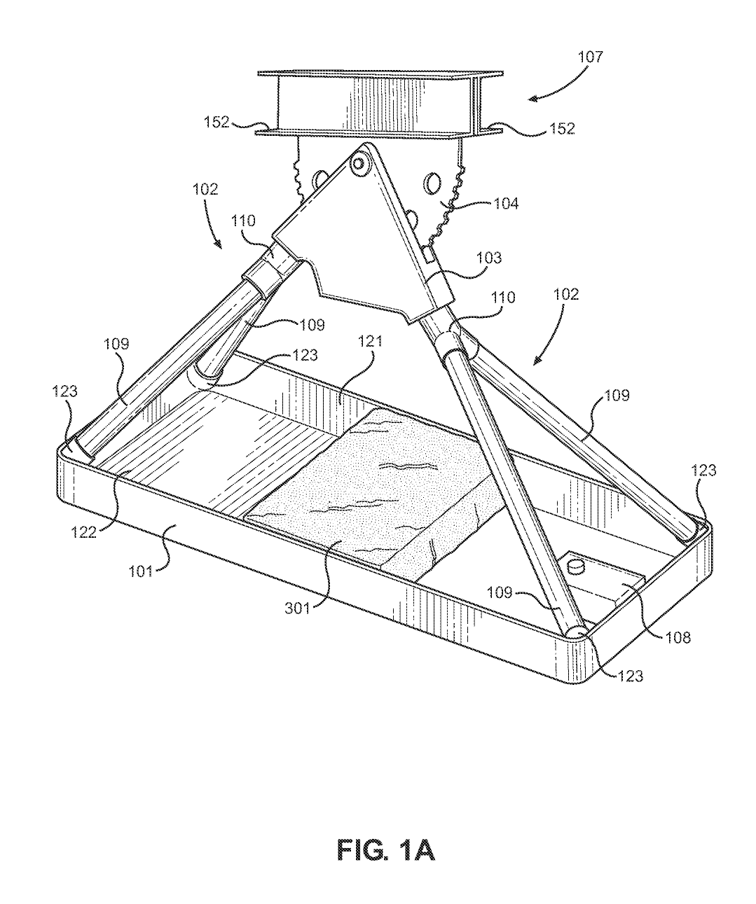

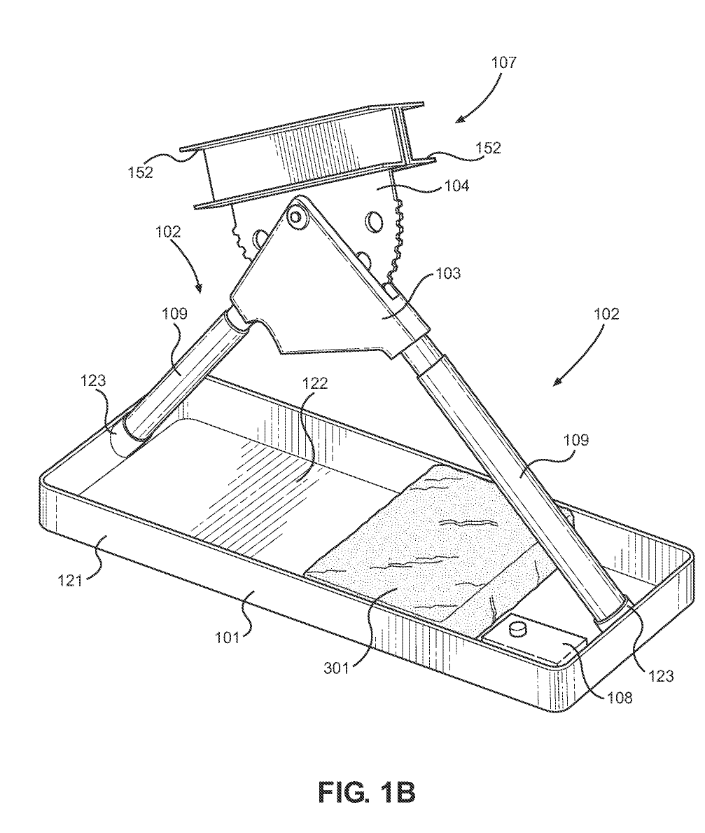

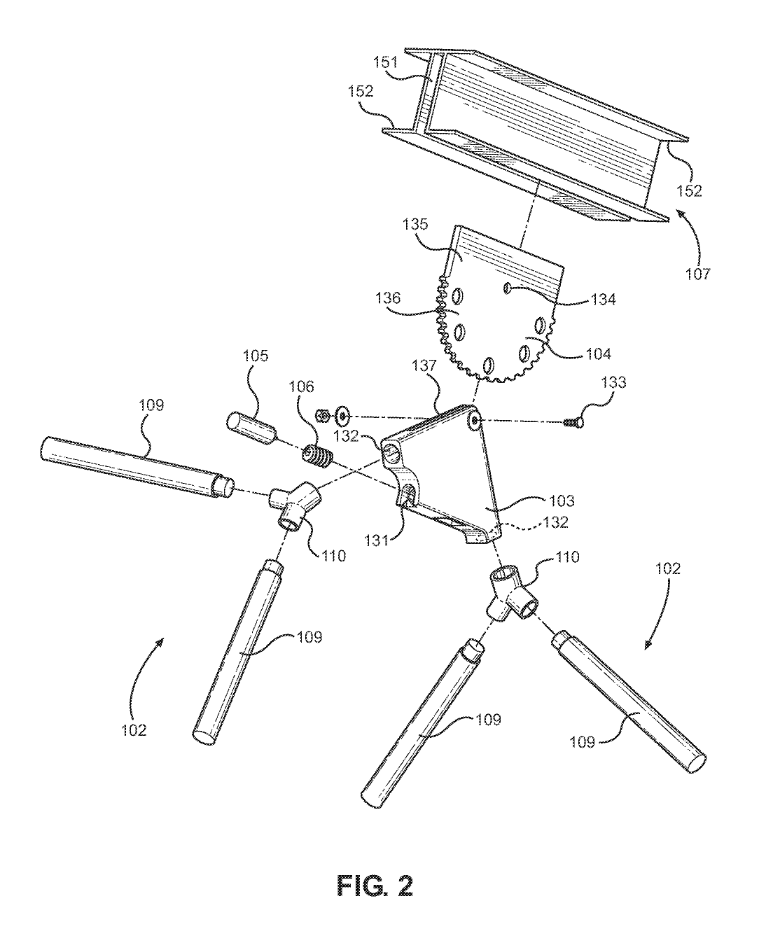

Referring now to FIGS. 1-2, there are shown perspective views of multiple embodiments of the present invention and an exploded view of an embodiment of the present invention. The depicted embodiments of the present invention comprise a base 101, a pair of struts 102 extending from the base 101, and a housing 103 supported aloft by the struts 102. The base 101 comprises a bottom wall 122 and a sidewall 121 extending vertically form the peripheral edge thereof, creating a partially enclosed open interior suitable for supporting one or more weights 301 therein for weighing down the apparatus.

In the embodiment of the present invention depicted in FIG. 1A, the struts 102 each comprise a pair of leg members 109 connected in a V-shaped configuration via a coupling 110 that serves as an intermediate connector between each of the leg members 109 and the housing 103. In the depicted embodiment of the present invention, the coupling 110 is Y-shaped and configured to removably connect the two leg members 109 of each strut 102 to a slot 132 disposed on the housing. In an illustrative embodiment of the present invention, the ends of the leg members 109 are removably connected to the base 101 via complementary slots 123 disposed along the interior face of the sidewall 121. The coupling 110 comprise an interior diameter in close tolerance to the diameter of the leg members 109 and the slots 123 likewise comprise an interior diameter in closer tolerance to the diameter of the coupling 110, thereby allowing the coupling 110, the leg members 109, and the slots 123 to be removably connected via press fit. The opposing end of the struts 102 are likewise removably connectable to slots 132 disposed on the housing 103. In the embodiment of the present invention depicted in FIG. 1B, the struts 102 each comprise a single leg member 109 removably connectable to the housing 103 and the base 101 via, e.g., press fit as discussed above.

The housing 103 comprises a motor 105, which is operably connected to a first gear. The first gear is configured to operably engage a second gear positioned through or within the housing 103. In an illustrative embodiment of the present invention, the first gear comprises a screw or worm gear 106 and the second gear comprises a panel lock gear 104, wherein the worm gear 106 and the panel lock gear 104 are arranged in a worm drive configuration whereby actuation of the worm gear 106 causes the panel lock gear 104 to rotate. The panel lock gear 104 is characterized by a circular or semi-circular shape, thereby causing actuation of the panel lock gear 104 to rotate the angle at which the panel lock 107 connected thereto is positioned. However, the depicted embodiment of the present invention is merely illustrative and the present disclosure contemplates other embodiments of the present invention utilizing other gear or gear-based mechanisms to pivot or otherwise adjust the angle at which secured solar panels are positioned.

An illustrative embodiment further comprises a panel lock 107 that is configured to support one or more solar panels therefrom. The panel lock 107 comprises a slot 151 and pair of receivers 152 disposed on opposing sides thereof. The receivers 152 are configured to receive the edge of a solar panel in order to support the solar panel aloft. The solar panels can be attached to the receivers 152 via any means known in the prior art, e.g. fasteners. In an illustrative embodiment, the receivers 152 comprises channels that are sized to receive the edges of a solar panel therein, such as by having a width that is equal to a close tolerance to the depth of the solar panel to be secured thereby. The channels are disposed on opposing sides of the panel lock 107 so that the solar panels secured to the panel lock 107 are held adjacently to each other. The panel lock 107 is connectable to the panel lock gear 104 such that rotation of the panel lock gear 104 adjusts the angle at which the panel lock 107 is positioned. In an illustrative embodiment of the present invention, the panel lock 107 comprises a slot 151 configured to receive an upper portion 135 of the panel lock gear 104 therein. The upper portion 135 of the panel lock gear 104 can be affixed to the panel lock 107 via any means known in the prior art.

An illustrative embodiment of the present invention further comprises a housing 103 disposed at the ends of the struts 102, which is configured to house a motor 105 to which a worm gear 106 is operably connected such that the worm gear 106 is rotatably driven by the motor 105. The housing 103 further comprises a gear slot 137 through which the panel lock gear 104 is insertable. The panel lock gear 104 is securable within the housing 103 via any means known in the prior art that allows for the rotation of the panel lock gear 104 within the housing 103. In the depicted embodiment of the present invention, the panel lock gear 104 is rotatably secured to the housing 103 via a fastener 133 that is secured through the housing 103 and a non-tapped aperture 134 disposed on the panel lock gear 104.

The motor 105 and the worm gear 106 are disposed within a recess 131 that is configured to leave the toothed portion of the worm gear 106 exposed, thereby allowing the worm gear 106 to engage the toothed portion 136 of the panel lock gear 104 when the panel lock gear 104 is inserted into the gear slot 137 and fastened in place. When actuated via the operably connected motor 105, the worm gear 106 rotates and thereby drives the rotation of the panel lock gear 104, which in turn causes the panel lock 107 and any solar panels secured thereto to pivot.

The housing 103 is configured to serve as a self-contained, interchangeable unit that can be quickly and easily replaced, without the need for skilled labor, in the event of failure of the motor 105, the worm gear 106, or another component contained therein. As such, the struts 102 are removably affixable to the housing 103 and the panel lock gear 104 can be quickly removed from the housing 103, such as via removal of a single fastener 133 as depicted in the illustrative embodiment of the present invention. Furthermore, the worm gear 106 and the rotatable connection between the panel lock gear 104 and the housing 103 are each positioned such that when the panel lock gear 104 is attached to the housing 103, the teeth of the panel lock gear 104 naturally engage the teeth of the worm gear 106 without the need for furthermore modification by the installer. In this illustrative embodiment of the present invention, the aforementioned features allow for the present invention to be rapidly deployed by unskilled laborers via simply securing the leg members 109 to the base 101 and the coupling 110, securing the coupling 110 to the housing 103, securing the panel lock gear 104 to the housing 103 via a single fastener 133, and then attaching the panel lock 107 to the upper portion 135 of the panel lock gear 104. These are simple steps that are quick and require minimal experience or tools to execute, allowing the present invention to be rapidly deployed for alternative electrical energy production during emergency situations, to remote locations, or for other temporary needs. Once deployed in the field, the present racking assembly can then be converted to permanent use as needed.

An illustrative embodiment of the present invention further comprises a logic 108, e.g. a microcontroller, which is operably connected to the motor 105 via either a wired or wireless connection. As used herein, “logic” refers to (i) logic implemented as computer instructions and/or data within one or more computer processes and/or (ii) logic implemented in electronic circuitry. In one embodiment of the present invention, the logic 108 is a controller or microcontroller. In a second embodiment of the present invention, the logic 108 is a timing circuit. The logic 108 selectively activates the motor 105, which in turn actuates the worm gear 106 to control the angle at which the panel lock 107 and any solar panels connected thereto are disposed, as discussed above. In one embodiment of the present invention, the logic 108 and the motor 105 are powered by a rechargeable battery, which in turn is powered by solar energy captured by the solar panel.

In one embodiment of the present invention, the panel lock 107 is fabricated from a metal material, thereby allowing the rack assembly to be self-grounding due to the system maintaining the necessary metal-to-metal connection at all times via the solar panels being connected to the metal panel lock 107. The rack assembly as a whole then serves as a common path for the discharge of excess electrical charge to the ground on which the base 101 of the rack assembly is resting.

In an alternative embodiment of the present invention, the logic 108 is wirelessly controllable via a remote control. The remote control allows for users to manually adjust the angle at which the rack assembly is positioned, in order to shake precipitation or debris from the surface of a solar panel supported by the rack assembly or override the positioning of the solar panel if the user is concerned about high winds.

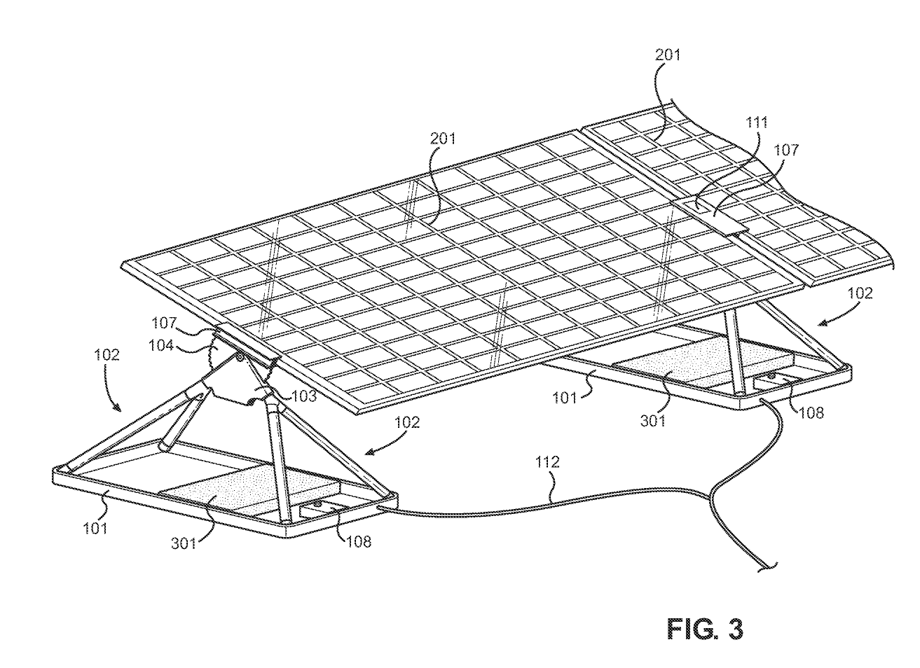

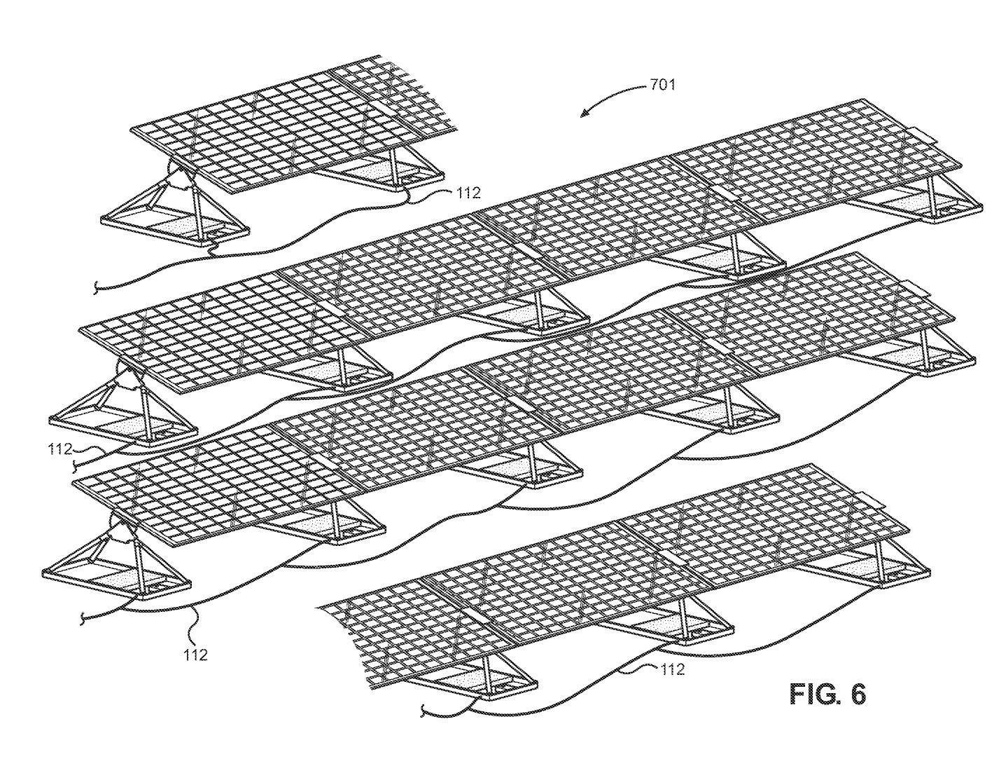

Referring now to FIGS. 3 and 6, there are shown perspective views of an embodiment of the present invention wherein two or more solar panels are connected in series. The panel lock 107 is configured to support two solar panels 201 in an adjacent configuration, thereby allowing one of the present solar panel racks to support up to two solar panels 201, two of the present solar panels racks to support up to three solar panels 201, and so on. The ability for multiple solar panels 201 to be supported by a rack assembly reduces labor and material costs associated with installing and maintaining a solar panel array. Furthermore, the ability for each solar panel 201 within an array to be supported by two separate rack assemblies allows for the operation of the solar panel 201 to continue even if one of the rack assemblies fails because the second, non-failing rack assembly can move

In one embodiment of the present invention, when multiple of the present solar panel rack assemblies are connected in series to support an array of solar panels 201, the logics 108 of each of the solar panel rack assemblies can be connected in order to synchronize the rack assemblies. The synchronization between the logics 108 ensures that a solar panel 201 supported between two of the rack assemblies is not subject to two non-synchronized rotational forces, which could potentially cause damage to both the solar panel 201 and the rack assembly.

In one embodiment of the present invention, the present rack assemblies are electrically connectable together via a common ground 112 when connected in an array 701. A common ground 112 for the array 701 obviates the need to individually ground each of the rack assemblies; rather, the rack assemblies can be electrically connected together via the common ground 112 and only one of the rack assemblies thereafter needs to be grounded for the entire array 701 to be grounded.

Furthermore, the arrangement of multiple of the present rack assemblies connected in series to support a plurality of solar panels together into an array provides substantial advantages over the prior art. The present rack assembly allows for sets of solar panels within the array to be separately controlled, thereby reducing the total amount of torque required to move each of the sets of solar panels making up the array as compared to conventional rack assemblies that are designed to move the entire array as a singular unit. Such conventional rack assemblies require huge amounts of torque to adjust as the array increases in size, thus requiring the utilization of high-powered motors. Such motors are extremely cumbersome, making the solar arrays unfit for rapid deployment, and require skilled labor to construct. Conversely, the present invention is configured to be a lightweight, rapidly deployable solar panel rack assembly that can be assembled and disassembled without the need for skilled labor.

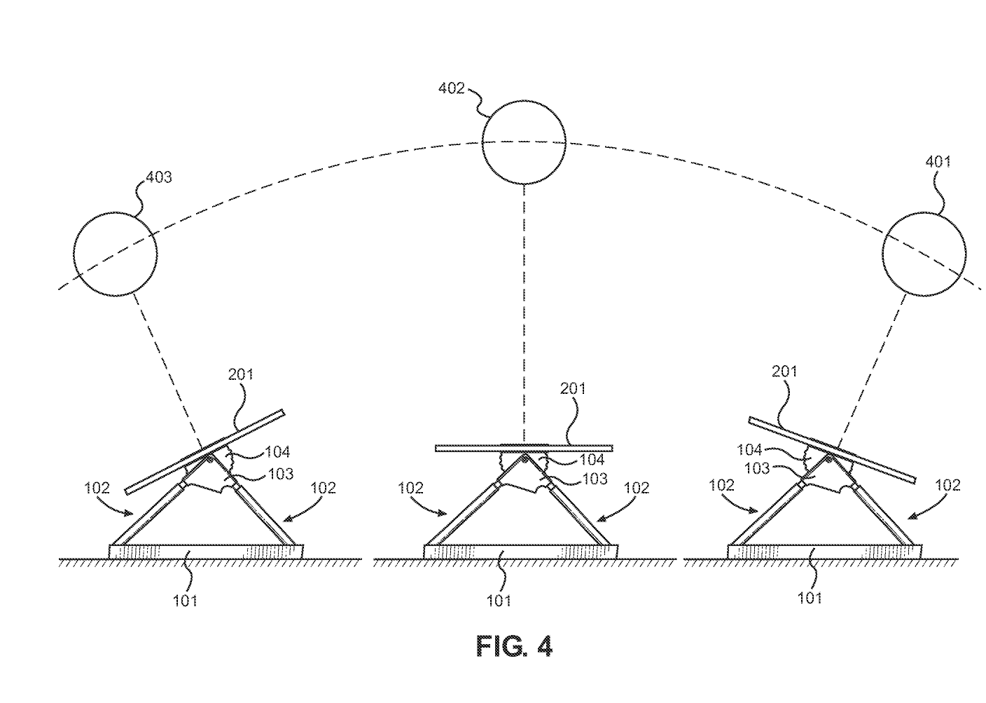

Referring now to FIG. 4, there is shown a diagram of the time-sensitive adjustment of the angle at which a solar panel is disposed by an embodiment of the present invention. The microcontrollers, which control the angle at which the solar panel 201 supported by the rack assembly is disposed via the motor within the housing 103, utilize a logic that selectively activates the motor in order to adjust the angle of the solar panel 201 is positioned in order to track the movement of the sun throughout the day. In an illustrative embodiment, the logic is a timing circuit that rotates the solar panel 201 ninety degrees in five-minute intervals through a twelve-hour cycle, which results in a rotation of the solar panel 625 degrees per interval. A rotation of that many degrees and at that interval essentially tracks the movement of the sun throughout the day with proper orientation of the present rack assembly.

The diagram shown in FIG. 4 demonstrates the concept of the movement of the present solar panel rack assembly described herein: When the sun is at a morning position 401, the rack assembly presents the solar panel 201 at approximately a negative forty-five degree position measured relative to the solar panel 201 being parallel to the base 101. When the sun is at its noon position 402, the rack assembly presents the solar panel 201 at a zero-degree position. When the sun is at an evening position 403, the rack assembly presents the solar panel 201 at a positive forty-five degree position. The solar panel 201 is transitioned between the positions at a set angle per set time interval. The logic is configured to automatically adjust the angle at which the solar panel 201 is positioned so that it is substantially perpendicular to the sun throughout the day. At the end of the day, the logic returns the solar panel 201 back to the starting or morning position in preparation for the following day.

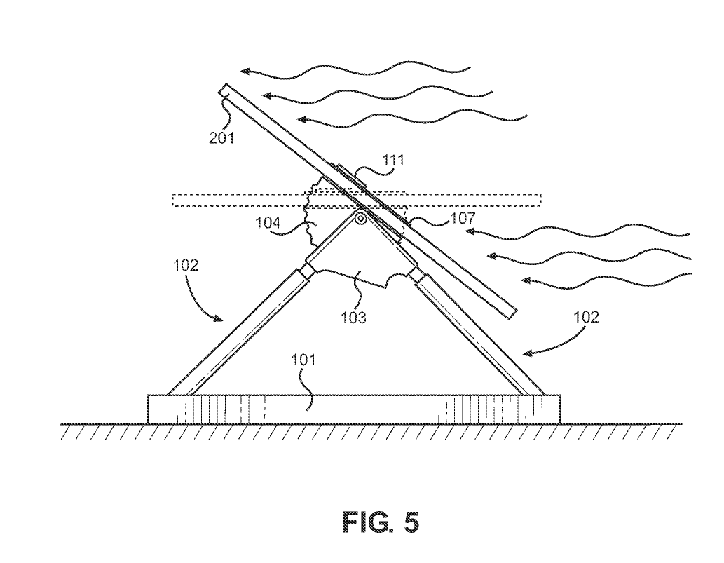

Referring now to FIG. 5, there is shown a diagram of the wind force-sensitive adjustment of the angle at which a solar panel is disposed by an embodiment of the present invention. The present rack assembly is configured to have a low profile in order to minimize wind force on the solar panel supported thereby. In an illustrative embodiment of the present invention, the height of the rack assembly is approximately one foot four inches. In order to further improve the performance of the rack assembly in minimizing potential damage from excessive wind speeds, an alternative embodiment further comprises a wind sensor 111 disposed on the rack assembly that is operably connected to the microcontroller and configured to detect excessive wind speeds.

When the wind speed exceeds a pre-programmed threshold, the logic overrides the current positioning of the solar panel 201 and adjusts the position of the solar panel 201 to a lockdown position. In the depicted embodiment of the present invention, the lockdown position is the noon or zero-degree position parallel to the base 101. When in this position, the solar panel 201 is presented parallel to the direction of the wind, minimizing the profile of the solar panel 201 and likewise minimizing the force exerted by the wind on the solar panel 201 due to the reduced surface area against which the wind can impinge. In one embodiment of the present invention, the threshold wind speed is 35 MPH. This embodiment of the present invention is configured to prevent damage to solar panels 201 and the rack assembly due to high-wind conditions, which is a common cause of destruction to conventional solar panel arrays.

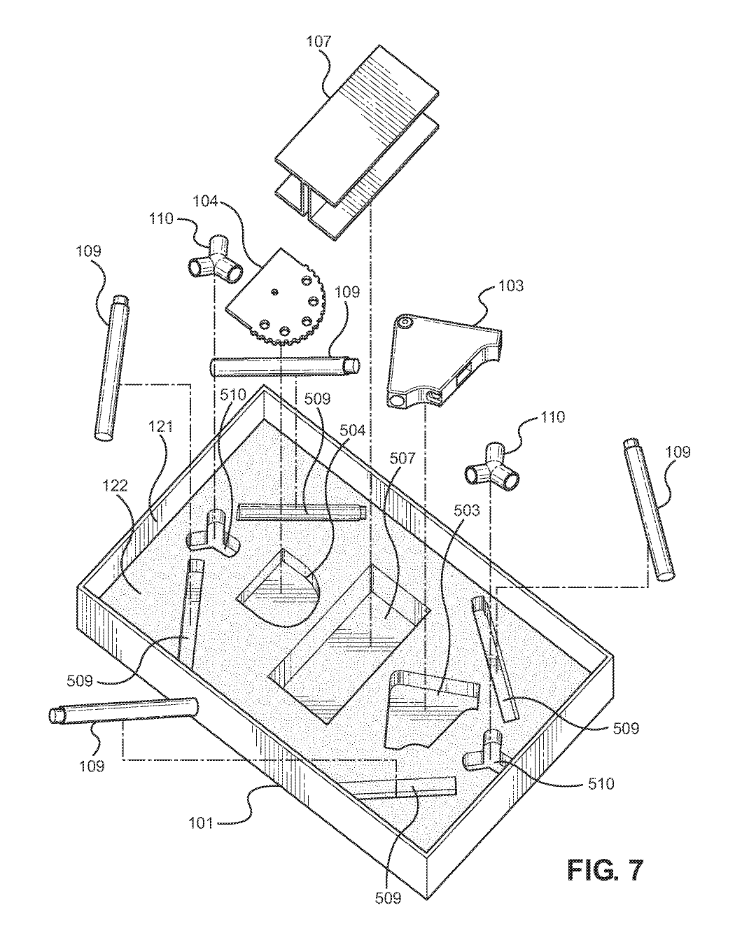

Referring now to FIG. 7, there is shown a perspective view of an embodiment of the present invention in a stowed configuration. An illustrative embodiment of the present invention is configured so that the volume of the partially enclosed open interior of the base 101 is greater than or equal to the sum of the volumes of the remaining components of the present invention, e.g. the leg members 109, the couplings 110, the housing 103, the panel lock gear 104, the panel lock 107, and any necessary fasteners. Further, the components of the rack assembly excepting the base 101 are configured to be arranged within the base 101 such that they do not extend beyond the lip of the sidewall 121, thereby allowing the present rack assembly to be transported in a compact and easily deployable manner.

In an alternative embodiment of the present invention, the bottom wall 122 of the base 101 further comprises a plurality of recesses, wherein each of the recesses corresponds to one of the non-base 101 components of the rack assembly. In this embodiment of the present invention, the rack assembly can be broken down and then each of the components can be placed within a corresponding recess configured to accept that component therein. This allows the rack assembly to be stored in a compact manner for transport. In an illustrative embodiment of the present invention, the bottom wall 122 comprises a coupling recess 510 for each coupling 110, a leg member recess 509 for each leg member 109, a panel lock gear recess 504 for the panel lock gear 104, a panel lock recess 507 for the panel lock 107, and a housing recess 503 for the housing 103.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A solar panel rack assembly, comprising:
a base;
a housing comprising a motor and a first gear, the first gear operably connected to the motor;
a strut extending from the base to the housing;
a panel lock comprising a receiver configured to receive an edge of a solar panel therein;
a second gear attachable to the panel lock, the second gear operably engaged with the first gear;
wherein actuation of the first gear rotates the second gear;
a logic operably connected to the motor, the logic configured to selectively activate the motor to rotate the panel lock a set angle at a set time interval.

2) The solar panel rack assembly of claim 1, further comprising:
a wind sensor configured to detect a wind speed;
wherein when the wind speed exceeds a threshold, the logic rotates the panel lock to a lockdown position.

3) The solar panel rack assembly of claim 2, wherein the lockdown position is parallel to the base.

4) The solar panel rack assembly of claim 1, wherein the first gear comprises a worm gear and the second gear comprises a semi-circular gear.

5) The solar panel rack assembly of claim 1, wherein the strut is removably connected to the base and the housing.

6) The solar panel rack assembly of claim 1, the strut further comprising a first leg member and a second leg member arranged in a V-shaped configuration.

7) The solar panel rack assembly of claim 1, the base further comprising:
a base wall;
a sidewall extending from a peripheral edge of the base wall;
the sidewall defining a partially enclosed interior volume.

8) The solar panel rack assembly of claim 1, the base further comprising a plurality of recesses, each of the plurality of recesses configured to receive at least one of the housing, the strut, the panel lock, or the second gear.

9) The solar panel rack assembly of claim 1, wherein the receiver comprises a U-shaped channel having a width in closer tolerance to a depth of the solar panel.

10) The solar panel rack assembly of claim 1, wherein the logic returns the panel lock to a set position at an end of a day.

11) A solar panel rack assembly, comprising:
a base comprising a base wall and a sidewall extending from a peripheral edge of the base wall, the sidewall defining a partially enclosed interior volume;
a housing comprising a motor and a worm gear, the worm gear operably connected to the motor;
a strut extending from the base to the housing, the strut comprising:
a coupling removably connectable to the housing;
a first leg member having a first end removably connectable to the base and a second end removably connectable to the coupling;
a second leg member having a first end removably connectable to the base and a second end removably connectable to the coupling;
wherein the first leg member and the second leg member are disposed in a V-shaped configuration;
a panel lock comprising a first U-shaped channel and a second U-shaped channel arranged adjacently;
wherein a width of each of the first U-shaped channel and the second U-shaped channel are equal to a depth of a solar panel;
a semi-circular gear attachable to the panel lock and rotatably attachable to the housing;
wherein attachment of the semi-circular gear to the housing causes the semi-circular gear to operably engage with the worm gear;
wherein actuation of the worm gear rotates the semi-circular gear;
a logic operably connected to the motor, the logic configured to selectively activate the motor to rotate the panel lock a set angle at a set time interval;
a wind sensor disposed on the panel lock, the wind sensor configured to detect a wind speed;
wherein when the wind speed exceeds a threshold, the logic rotates the panel lock to a lockdown position.
